(19) United States
(12) Patent Application Publication
(10) Pub. No.: US 2011/0037274 A1
(43) Pub. Date: Feb. 17, 2011

(54) ASSEMBLAGE OF TECHNOLOGIES FOR THE RENEWABLE ENERGY

(76) Inventor: Aniello Scialli, Durazzano (IT)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/808,518

(22) PCT Filed: Dec. 9, 2008
(86) PCT No.: PCT/IT2008/000752

§ 371 Date: Aug. 7, 2010

(30) Foreign Application Priority Data
Dec. 17, 2007 (IT) DP2007A000027

(51) Int. Cl. H02K 7/18; F03G 7/10

(52) U.S. Cl. 290/1 R; 74/DIG. 9

(57) ABSTRACT

The project is based on system of power fed by reduction gears with electric motors, dynamic oil, other. With production of job mechanic and energy other in exit to according to of the type of job to be done how multiplier pomps oil dynamics alternator transmissions wheels engine other, with manifold ways of use.

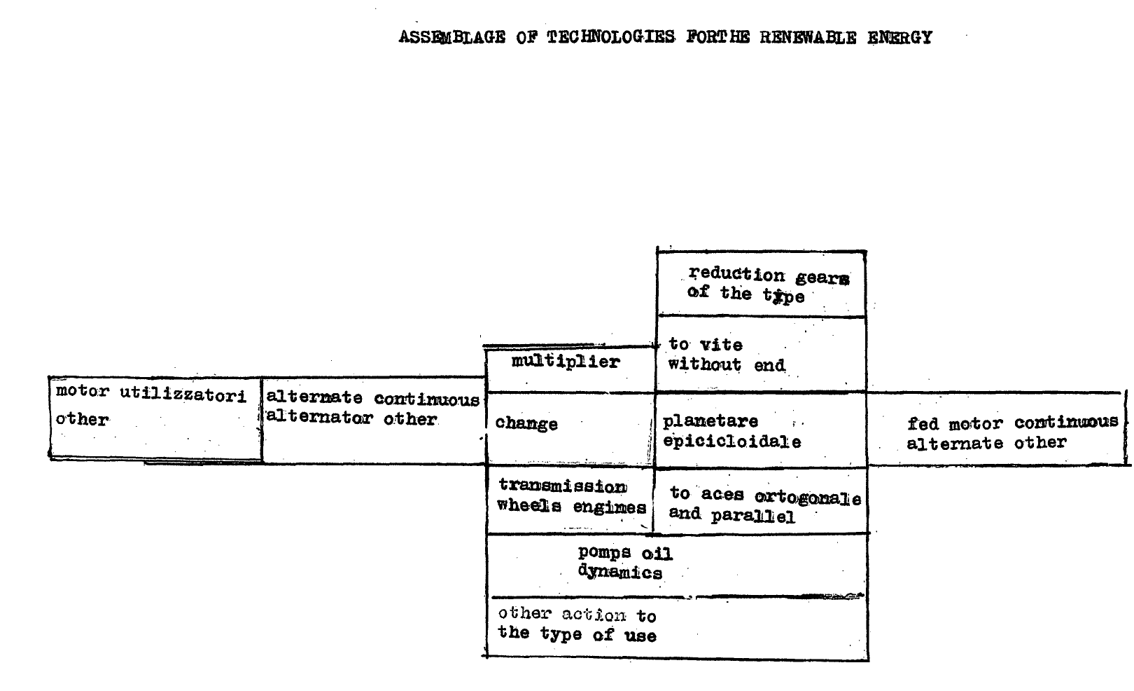

### TECHNICAL REPORT

1. Preexisting Technique

I don't know any preexisting technique, but I knew the effects of the single element. I have attended schools of physics to Firenze and autodidactic with a lot of ambitions and many artisan years, where I have touched with hand some physical effects.

2. Exposure of the Invention

The based projet on system of power fed by reduction gear with electric motor, dynamic oil, other. With production of job mechanic and energy with one or more reduction gears (if necessary combined, adapted and improved to the specific use), and operated by one or more electric motors (continuous alternate) oil dynamic, with whatever mean, with speed second variable the to make himself, transmitting power, to the transmissions, change, multiplier pomps, wheels engines, alternators it continues alternate other predisposed to according to the make himself. With utilizzatori: motor, accumulators, lights, resistances, other. This system has the manifold opportunities of exploit it as any mean of transport, of job mechanic, of production of renewable energy, other. His function: motion perpetual perfect car in degree to resolve all the problems of the moment environmental, economic effect shuts imploring the nuclear one (it is always a threat) and so many other things that damage the existence of the planet.

### BEST WAY TO EFFECT THE INVENTION

The realization can happen in manifold ways for the energy electric autonomous use and preferable to convert all the utilizzatoris for central a way is worth the other solo matter of power and necessity for half furniture you can be exploited all the already existing techques suiting the all with electric motors for that hydraulic pomps oil dynamics wheels engines other with utilizzatori of any type and all operated with the same system.

### BRIEF DESCRIPTION OF THE SKETCHES

Based on system of power of thereduction gears fed from any type of power electric motor continuous alternate oil dynamic other. With one or more reduction gears (A)-(A1)-(A2)-(An) also combined operated by one or more motors (B)-(Bn)-(H) other in exit to the type of use (C)-(D)-(E)-(F)-(H) and so many others to according to of the necessities to follow with (G)-(Gn)-(I)-(In).

1. all the advantages of the system;

2. all the rights that the found one offers;

3. for the manifold ways of realization;

4. for as expressed in the descriptions.
